(19) United States
(12) Patent Application Publication
(10) Pub. No.: US 2014/0259627 A1
(43) Pub. Date: Sep. 18, 2014

(54) SELF-THREADING FASTENER

(71) Applicant: APPLE INC., Cupertino, CA (US)

(72) Inventors: Conor P. LENAHAN, San Francisco, CA (US); Taylor H. GILBERT, Sunnyvale, CA (US); Piotr S. TRZASKOS, Saratoga, CA (US); Alex C. Yeung, South San Francisco, CA (US)

(73) Assignee: Apple Inc., Cupertino, CA (US)

(21) Appl. No.: 13/843,199

(22) Filed: Mar. 15, 2013

(51) Int. Cl. F16B 39/284

(52) U.S. Cl. CPC F16B 39/284
USPC 29/525.05; 411/176

(57) ABSTRACT

The embodiments described in this paper relate generally to a fastener configured to reduce a risk of doing damage to a high cost component. Various embodiments of fasteners configured to be threaded during insertion are described. This is accomplished by selecting a material for an engaging portion of the fastener that is soft enough to yield to a set of threads to which it is driven into. In this way, a complementary threading pattern is formed on an exterior surface of the fastener as it is twisted against threading of the high cost component to which the fastener is configured to be coupled.

### BACKGROUND

1. Technical Field

The described embodiments relate generally a fastening mechanism. More specifically, a securing mechanism having a self securing aspect with respect to a corresponding capture device is disclosed.

2. Related Art

In conventional assembly and manufacturing processes, in order to assure a secure fit, a prior art fastener is generally manufactured to have material properties that are harder and/or less ductile than the material used to form the corresponding threaded capture feature (such as a threaded boss). Misalignment or over-torquing of the prior art fastener often results in damage to the threading of either or both the prior art fastener and the threaded boss. Damage to the threaded boss can require component rework or component rejection if acceptable rework is not possible.

Therefore, what is desired is a self securing mechanism having little propensity to damage a corresponding capture device.

### SUMMARY

This paper describes various embodiments that relate to an apparatus, system, and method for use of a self-threading fastener.

In a first embodiment, a method for securing a first component to a second component is disclosed. The method includes at least the following steps: (1) arranging a first end of a fastener through an opening in the first component and against a threaded bore disposed in the second component; and (2) driving the first end of the fastener against a number of threads disposed along an inside surface of the threaded bore such that an outer surface of the fastener is deformed against the number of threads, the deformation of the outer surface forming a threading pattern along the outer surface of the fastener that is complementary with the plurality of threads. The threading pattern interacts with the plurality of threads to secure the first end of the fastener within the threaded bore of the second component. The outer surface of the fastener is not rigid enough to cause damage to the plurality of threads.

In another embodiment, a fastener is disclosed. The fastener is configured to ground a printed circuit board (PCB) to a housing. The fastener includes at least the following: a head portion; and a deformable body portion. The deformable body portion includes at least the following features: a conductive shaft; a number of protrusions extending radially from the shaft; and a non-conductive over-mold covering at least the shaft and protrusions of the body portion. When the deformable body portion of the fastener is driven against a threaded bore of the housing, a threading pattern is formed along an exterior surface of the over-mold portion. The threading pattern cooperates with a number of threads disposed within the threaded bore to secure the fastener to the housing. The head portion is configured to be electrically coupled to a conductive element disposed on a first surface of the PCB.

In yet another embodiment, an electronic device is disclosed. The electronic device includes at least the following: a conductive housing, having a threaded bore; a fastener having a deformable body portion with a first end configured to engage the threaded bore of the electronic device housing; and a printed circuit board secured to the threaded bore of the conductive housing by the fastener. When the first end of the deformable body portion is driven into the threaded bore, the first end deforms about a number of threads disposed within the threaded bore, thereby securing the first end of the deformable body portion within the threaded bore.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings in which:

FIG. 1A shows a self-threading fastener having a shaft with a cross shaped cross-section;

FIG. 1B shows a self-threading fastener having tapered protrusions extending radially from the shaft;

FIG. 2 shows a fastener embodiment having variable protrusion geometry;

FIGS. 3A-3D show how a self-threading fastener can be utilized to electrically and mechanically couple a component to a conductive housing;

FIGS. 4A-4D illustrate a process by which protrusions can be formed from a shaft of a self-threading fastener;

FIGS. 5A-5B show cross-sectional close up views of threading being formed on a fastener as it is driven into a threaded bore;

FIG. 6 shows another embodiment in which an exterior portion of a fastener is at least partially threaded;

FIGS. 7A-7B show a conductive fastener formed from a single material configured to couple two components together;

FIG. 8 shows a block diagram describing a process for inserting a self-threading fastener through an electrical component and into a threaded bore of a housing; and

FIG. 9 shows a block diagram describing a process for forming a self-threading fastener.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

A self-threading fastener configured to mate with a corresponding threaded capture feature having a threaded central bore is described. In one embodiment, the self-threading fastener can take the form of a screw or other such fastening device. Generally speaking, the self-threading fastener can include a body portion having a size and shape in accordance with the threaded central bore. In some embodiments, the body portion can include a surface into which are formed a plurality of threads corresponding to threads associated with the threaded central bore. The threaded body portion (and the corresponding plurality of threads) can be formed of a first material that can be generally more malleable than a second material used to form the threaded capture device. For example, the first material can be made of aluminum whereas the second material can be made of steel. Accordingly, the difference between the material properties of the fastener and the threaded capture device can reduce any potential damage caused during a fastening operation. For example, when the threaded body portion is inserted into and mechanically engages with the threaded central bore, the first material will deform with respect to the second material to essentially take on a shape complementary to the threaded central bore in what can be referred to as self-threading. In this way, damage to the threaded capture device can be essentially eliminated while maintaining a secure coupling between the self-threading fastener and the threaded capture device.

In some embodiments a self-threading fastener can replace other types of fastening constructs. For example, some electronic device designs involve electrically coupling two parts together using adhesive and conductive foam. While the conductive foam provides a cushion between components and is unlikely to cause damage to components with which it is in contact, the conductive foam can break down over time and may not provide a satisfactory electrical connection between components. The self-threading fastener can be constructed from conductive material having material properties such that a likelihood of damage to neighboring components can be minimized. In some cases, portions of the self-threading fastener can be made of insulating material so that only specific portions of the coupled components are electrically coupled.

In one specific embodiment, a self-threading fastener can be made from a variety of materials. A relatively stronger shaft portion made from, for example, steel or aluminum can be encased by a non-conductive over-mold portion. The shaft portion can include thin protrusions aligned orthogonally with respect to threading into which the fastener is designed to be secured. The thin protrusions can provide a number of advantages. First, the thin protrusions can inhibit the over-mold portion from rotating independently of the shaft, as the protrusions can interact with the over-mold portion to prevent slipping between the shaft and over-mold portion as the shaft is rotated. Second, as the over-mold portion of the fastener is deformed by the threading, the thin protrusions can eventually come into contact with the threading. When the threading and shaft are both conductive the threading can be electrically coupled to the shaft by that contact. The thin protrusions can be deformed, or even cut in some cases, by the threading, causing increased surface area contact between the conductive elements and thereby enhancing the electrical coupling. In many cases, even when the fastener shaft and threading have about the same strength, the thin profile of the protrusions can lower the resistance of the protrusion relative the threading. It should be noted, that since positioning of the protrusions can be variable along the shaft portion, the protrusions engage the threads at any desired position of the fastener with respect to the opening inside which the threads are disposed. In this way, the fastener can be configured to provide increased rotational resistance as the fastener is being driven against threading when a desired positioning of the fastener with respect to the opening has been reached. In such a configuration, an automated driver can be configured to cease driving when a predefined rotational resistance is detected.

In another embodiment, a fastener can be formed from a single conductive material having a lower yield strength and/or plasticity than a threaded bore or boss to which it is designed to be attached. In one specific embodiment the conductive material can be a polymer doped with graphite. The fastener can be configured to mechanically couple a first substrate to another component such as, for example, a housing. The fastener can be twisted or driven into a threaded bore disposed along a surface of the housing. The threaded bore has a number of threads configured to retain the inserted fastener by deforming the inserted portion of the fastener. The conductive material of the fastener is configured to electrically couple the fastener to the threaded bore, which can also be made from a conductive material such as, for example, aluminum. The single material construction of the fastener can allow for low production costs as in many cases it can be forged or injection molded in a single step.

These and other embodiments are discussed below with reference to FIGS. 1A-9; however, those skilled in the art will readily appreciate that the detailed description given herein with respect to these figures is for explanatory purposes only and should not be construed as limiting.

FIGS. 1A-1B show various embodiments of self-threading fastener 100. FIG. 1A shows one embodiment of self-threading fastener 100. Self-threading fastener 100 has two major components: (1) head portion 102; and (2) body portion 104. Head portion 102 can include driving feature 106. Driving feature 106 can be operative to twist an end of body portion 104 against a set of threads. While driving feature 106 is depicted as a Philips-shaped driving feature, it should be noted that any driving feature configuration such as a single slot geometry, a pentalobe geometry, or any other driving feature operative to allow fastener 100 to be driven into a set of threads, is possible. Body portion 104 includes shaft 108 having protruding features 110 which are encased by an over-mold portion 112. Over-mold portion 112 is indicated by a dotted region in FIGS. 1A and 1B. Shaft 108 is integrally formed with head portion 102 and extends normal from a bottom surface of head portion 102 along the y-axis, as depicted. Protruding features 110 can be configured to be narrow in width. In this way, protruding features as depicted can provide strength to the fastener in resisting a bending moment or shearing force along for example, the Z-axis, but much lower force resistance against any threading that protruding features 110 comes in contact with. Protruding features 110 can also be operative to prevent over-mold portion 112 from slipping with respect to shaft 108 during a securing operation. Risk of damage to threading by fastener 100 can be minimized even when protruding features are made of tougher material than the material the threading is disposed along, because the narrow geometry of the protrusion can substantially reduce the strength of the protrusions. Over-mold portion 112 can be configured to plastically deform as fastener 100 is driven into a threaded bore. In some embodiments over-mold portion 112 can be configured to return to a pre-deformed position when removed from a threaded bore, while in other embodiment, deformation of over-mold portion 112 is more permanent generally making fastener 100 a one-time use fastener. FIG. 1B shows an embodiment in which end portions of protrusions 110 are tapered so that as fastener 150 rotates in the Y-axis, rigidity at the end of each of the tapered protrusions 110 with respect to a threaded capture feature can be minimized, thereby reducing a likelihood of damaging or compromising threading of the threaded capture feature during both insertion and removal of the fastener.

FIG. 2 shows a fastener embodiment having variable protrusion geometry. In this particular embodiment, fastener 200 is depicted with a slot shaped driving feature 206 as opposed to the Philips-shaped driving feature 106 depicted in FIGS. 1A and 1B. Body portion 204 includes shaft 208 which can be integrally formed with head portion 202. Shaft 208 can be configured with a number of protrusions 210. Shaft 208 can have a circular cross-section as depicted or can have an elliptical or polygon shaped cross-section. In some embodiments, protrusions 210 can be machined from shaft 208. Machined protrusions 210 can be formed at any point along shaft 208 and extend at any angle from shaft 208. In this way, each of protrusions 210 can be configured to interact with specific portions of a threaded capture feature. By varying height, width, and/or geometry of the machined protrusions, various levels of force can be applied at various predefined positions of the threaded capture feature. In some embodiments, machined protrusions 210 can be arranged on opposing sides of shaft 208, creating a symmetrical cross-section that balances exerted force between opposite sides of fastener 200. It should be noted that in some embodiments, body portion 204 can have a varying size cross-section configured to be self threaded against two separate and distinct threaded capture features. In such an embodiment, protrusions 210 can also be configured to have varying sizes to match threads having diameters of varying size. In this way a fastener can be electrically coupled to each of at least two threaded capture features.

FIGS. 3A-3D show how a self-threading fastener can be utilized to electrically couple a component to a conductive housing. In FIG. 3A, fastener 302 is inserted through a printed circuit board (PCB) 304. PCB 304 can include any number of electrical traces including trace 306, disposed on a top surface of PCB 304. In some embodiments, PCB 304 can be a flexible PCB. Printed circuit board 304 can have, as depicted, an opening through which fastener 302 is just narrow enough to fit; in other embodiments, that opening can include threading to more securely couple fastener 302 to PCB 304. A configuration in which the opening in PCB 304 includes threading can be combined with a fastener 302 having a body portion with a variable cross-section, thereby allowing a wider diameter segment of the body portion to engage PCB 304 and a narrower diameter segment of the body portion to engage housing 312. A chamfered end 308 of fastener 302 is depicted coming into contact with threaded bore 310 of housing 312. In some embodiments, threaded bore 310 of housing 312 can be part of a boss integrally formed with the rest of housing 312. Threaded bore 310 of housing 312 can include threading 314. FIG. 3B shows fastener 302 positioned within threaded bore 310 and deformed by threading 314. Threading 314, as depicted, can have gradually thicker threads towards a bottom portion of threaded bore 310. In this way, only that bottom portion of threading 314 can come into contact with shaft 316 of fastener 302. In some embodiments, only protruding portions of shaft 316 can come into contact with threading 314, which, as previously described, can reduce a likelihood of doing damage to threading 314. Head portion 318 of fastener 312 can be in direct contact with electrical trace 306. In embodiments where PCB 304 is a flexible PCB, tension can be placed upon flexible PCB 304 to establish a reliable conductive coupling 320 between electrical trace 306 and head portion 318 of fastener 302. In some embodiments, fastener 302 can fix a bottom surface of PCB 304 against a top surface of housing 312. In order to keep the two layers from coming into direct contact with one another, a non-conductive spacer can be added between a bottom surface of PCB 304 and housing 312, thereby keeping the bottom surface of PCB 304 isolated from housing 312. In any of the described configurations conductive coupling path 320 can provide an efficient grounding path for signals running along a top surface of PCB 304. The grounding path can couple the signals to the housing, thereby providing a chassis ground for the signals running along PCB 304. In some cases PCB 304 can be coupled to an antenna, the coupled chassis ground can then be configured to increase performance characteristics of the antenna.

FIG. 3C shows one way in which fastener 302 can be efficiently removed. By heating fastener 302 with heat source 322, over-mold portion 324 of fastener 302 can be softened, thereby making removal of fastener 302 from housing 312 and PCB 304 substantially easier. In some embodiments, heating fastener 322 prior to removal can beneficially reduce a risk of shedding portions of fastener 302 into housing 312 during removal of fastener 302. FIG. 3D shows a cross-section of fastener 302 during removal. As depicted, over-mold portion 324 of fastener 302 is substantially changed as a result of the removal and in many cases can be disposed of due to its generally low cost. Since shedding of the fastener can be avoided, a new fastener can be used to replace it without having to worry about stray bits of the old fastener rattling around the housing after a repair or replacement operation is complete.

FIGS. 4A-4D illustrate a process by which protrusions can be formed from a shaft of a self-threading fastener. FIG. 4A shows a cross-sectional view of a shaft portion 402 of a fastener 400. In this embodiment, the cross-section is circular, but in other embodiments, the cross-section can be elliptical, or in some cases can have a polygon shaped cross-section. In FIG. 4B, shaft portion 402 of fastener 402 is hit simultaneously by two tools 404 and 406. The tools can cause deformation of shaft 402. The simultaneous striking by the two tools can cause the deformation to be substantially symmetric in nature. Subsequent to the two tools contacting shaft 402, FIG. 4C shows how shaft 402 can be heated so that metal tends to flow between the two tools, thereby causing formation of protrusion 408. The two tools can be configured to apply the heating or in other embodiments another heating source can be applied to the shaft of the fastener. Once shaft 402 is allowed to cool, tools 404 and 406 can be removed after which FIG. 4D shows a finished cross-section of shaft 40s with formed protrusion 408. This process can be repeated multiple times to form a number of protrusions extending from shaft 402, prior to addition of an over-mold portion to fastener 400.

FIGS. 5A-5B show cross-sectional close up views of a threading pattern being formed on a fastener as it is driven into a threaded bore. In FIG. 5A, fastener 502 is being mechanically coupled to housing 504 by rotating fastener 502 about an axis parallel to the X-axis. As fastener 502 is rotated, over-mold portion 506 can be deformed with respect to threads 508. Protrusion 512 of shaft 510 is depicted having a geometry similar to geometry shown in FIG. 2 and FIGS. 4A-4D. It should be noted that the illustrated protrusion 512 can take many forms and this particular depiction should not be construed as limiting. FIG. 5B shows fastener 502 after it has been driven further against threads 508. Protrusion 512 can now be seen interacting with threading 508 of housing 504. In this depiction, protrusion 512 is deformed by threads 508. In other embodiments, protrusion 512 can undergo plastic bending as it contacts threading 502, while in yet other embodiments no deformation occurs to the protrusion and contact between protrusion 512 and threading 508 can cause a sufficient amount of torque to indicate to a driving mechanism that protrusion 512 is in contact with at least one of threads 508. Regardless of the embodiment, contact between protrusion 512 and threads 508 can form an electrically conductive pathway between fastener 502 and housing 504. In configurations in which fastener 502 is in contact with another electrical component (see FIGS. 3A-3D), fastener 502 can form a grounding pathway between components, allowing a signal on the other electrical component to be grounded to housing 504. Placement of protrusion 512 away from a leading edge of shaft 510 can be beneficial as such a placement allows over-mold portion 506 to become fully engaged with threading 508 prior to contact between protrusion 512 and threading 508, thereby stopping rotation of fastener 502 with respect to housing 504.

FIG. 6 shows another embodiment in which an exterior portion of fastener 600 is at least partially threaded. Threading pattern 602 formed on an exterior portion of body portion 604 of fastener 600 can be used to reduce a failure rate of fastener 600. Without at least a partially formed threading pattern, in some embodiments, fastener 600 can be misaligned with respect to its desired orientation with respect to a threaded bore. In such a case, threading disposed on the housing can cause the fastener to be ruined. By at least partially pre-forming a threading pattern on fastener 600, pre-formed threading pattern 602 in conjunction with chamfered end 606 can cooperate to increase the reliability of screw insertion during assembly of an electronic device. Partially formed threading pattern 602 can extend only a fraction of the distance into fastener 600 when compared to a distance into which the threading is designed to penetrate. At this point, it should be noted that in some embodiments self-threading fastener 600 does not include a metallic shaft running down its center. In some embodiments, all of fastener 600 can be made of a material softer or more deformable than the threaded capture feature to which it is to be coupled. For example, in some embodiments an aluminum screw can be used in conjunction with steel threading. In other embodiments, a conductive polymer (i.e. hard plastic doped with graphite or other conductive particles) can be used in conjunction with a threaded capture feature constructed from aluminum.

FIGS. 7A-7B shows a conductive fastener 702 formed from a single material and configured to couple two components together. In some embodiments the single material can be a conductive polymer. In FIG. 7A, fastener 702 is disposed through an opening of an electrical component 704. Electrical component 704 can be a flexible printed circuit board (PCB) having a number of electrical traces disposed on at least a top surface of the flexible PCB, including electrical trace 706. In this embodiment, a non-conductive spacer 708 can be disposed between electrical component 704 and housing 710, thereby preventing direct contact between a bottom surface of electrical component 704 and a top surface of housing 710. In FIG. 7A, fastener 702 is not yet in contact with threaded bore 712. In some embodiments, threading on threaded bore 712 can be a series of dull ridges designed to press into and deform fastener 702 as opposed to cutting into the material of fastener 702. In other embodiments a sharp threading configuration can be used that does cut into fastener 702 during rotation of fastener 702 into threaded bore 712. Sharper threads can be desirable when for example; a stronger mechanical coupling is desired. In FIG. 7B, fastener 702 is shown fully engaged with threaded bore 712. In some embodiments, fastener 702 can be vertically driven into aperture 712 without any need for twisting during insertion. In such an embodiment, it is important to note that material properties of fastener 702 are such that no shedding or extremely minimal shedding of material occurs during insertion. In still other embodiments, fastener 702 can be designed to be rotatably driven into housing 710. Deformation of fastener 702 can be temporary in some embodiments, allowing fastener 702 to return to a pre-fastening shape upon removal. In each of the described embodiments, fastener 702 can be operable to electrically ground electrical trace 706 to housing 710. In this way, a component in electrical contact with electrical trace 706 can be grounded to housing 710 through grounding path 720. In addition to grounding electrical components, fastener 702 is also operable to mechanically constrain electrical component 704 to housing 710.

FIG. 8 shows a block diagram describing a process 800 for inserting a self-threading fastener through an electrical component and into a threaded bore of a housing. In a first step 802 a fastener is inserted through an opening or aperture of a first electrical component. The first electrical component can be a printed circuit board (PCB) or flexible PCB configured to transfer signals and/or power between electrical components. In one embodiment, the self-threading fastener can be configured to fasten a flexible PCB in electrical contact with an antenna to a portion of the housing. In step 804, a threading pattern is formed in an end of the fastener by threading disposed on a second component. In embodiments where a non-conductive over-mold portion is present, the threading can cut into the fastener just enough to establish an electrical coupling between a conductive shaft portion and conductive threading on the second component. In step 806, the fastener is driven against the threading until a head portion of the fastener is in contact with a conductive element disposed on a top surface of the first component. In this way, the fastener electrically couples a top surface of the first component to the threading disposed on the second component.

FIG. 9 shows a block diagram describing a process 900 for forming a self-threading fastener. In a first step 902, a metallic fastener can be formed of a conductive material. The metallic fastener can include a head portion and a body portion. The body portion can include a driving feature while the body portion includes at least a shaft protruding normal from a surface of the head portion. In step 904, a number of protrusions can be formed from the shaft of the body portion. In some embodiments, the protrusions can be substantially formed at the completion of step 902. For example, the formed shaft can have a cross shaped cross-section, each of the protruding ends of the cross forming a protrusion along an entire length of the shaft. In other embodiments, a tool or tools can be used in conjunction with heat to form protrusions arranged at a variety of angles and positions along the shaft. At step 906, the machined metallic fastener can be placed in an injection molding cavity after which hard plastic can be overmolded around the shaft and protrusions of the metallic fastener. In some embodiments, the resulting over-mold portion can have substantially weaker material properties than the shaft and head portions of the fastener.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for securing a first component to a second component, the method comprising:
arranging a first end of a fastener through an opening in the first component and against a threaded bore disposed in the second component; and
driving the first end of the fastener against a plurality of threads disposed along an inside surface of the threaded bore such that an outer surface of the fastener is deformed against the plurality of threads, the deformation of the outer surface forming a threading pattern along the outer surface of the fastener that is complementary with the plurality of threads,
wherein the threading pattern interacts with the plurality of threads to secure the first end of the fastener within the threaded bore of the second component, and wherein the outer surface of the fastener is not rigid enough to cause damage to the plurality of threads.

2. The method as recited in claim 1, wherein the driving of the first end of the fastener against the plurality of threads comprises twisting the first end of the fastener against the plurality of threads.

3. The method as recited in claim 1, wherein the driving of the first end of the fastener against the plurality of threads comprises vertically driving the first end of the fastener into the plurality of threads.

4. The method as recited in claim 2, wherein the interaction between the plurality of threads and the threading pattern electrically couples at least the fastener to the second component.

5. The method as recited in claim 4, further comprising forming a partial threading pattern into the outer surface of the fastener, prior to arranging the first end of the fastener against the threaded bore, the partial threading of the outer surface helping to align the fastener with respect to the threaded bore during the securing.

6. The method as recited in claim 4, further comprising:
continuing to drive the first end of the fastener against the threaded fastener until a head feature of the fastener comes into direct contact with a top surface of the first component such that a conductive element disposed on the top surface of the first component is electrically coupled to the fastener by way of the head feature.

7. The method as recited in claim 4, wherein concurrently with the forming of the threading pattern in the fastener, another plurality of threads disposed along an inside surface of the opening of the first component is configured to form another threading pattern on the fastener, the other threading pattern configured to mechanically couple the fastener directly to the plurality of threads of the opening.

8. The method as recited in claim 7, wherein interaction between the other threading pattern and the plurality of threads disposed within the opening electrically couples the fastener to the first component.

9. The method as recited in claim 4, wherein during the forming of the threading pattern, a protrusion integrally formed with a metallic shaft disposed beneath the outer surface of the fastener comes into contact and is deformed by the plurality of threads, such that the deformed protrusion electrically couples the fastener to the plurality of threads.

10. A fastener configured to ground a printed circuit board (PCB) to a housing, the fastener comprising:
a head portion; and
a deformable body portion, comprising:
a conductive shaft,
a plurality of protrusions extending radially from the shaft, and
a non-conductive over-mold covering at least the shaft and plurality of protrusions of the body portion,
wherein when the deformable body portion of the fastener is driven against a threaded bore of the housing, a threading pattern is formed along an exterior surface of the non-conductive over-mold, the threading pattern cooperating with a plurality of threads disposed within the threaded bore to secure the fastener to the housing, and wherein the head portion is configured to be electrically coupled to a conductive element disposed on a first surface of the PCB.

11. The fastener as recited in claim 10, wherein the plurality of protrusions are configured to make contact with the plurality of threads while the threading pattern is being formed, the plurality of protrusions being further configured to deform against the plurality of threads, thereby electrically coupling the first surface of the flexible PCB to the set of threads of the housing.

12. The fastener as recited in claim 11, wherein a non-conductive spacer is disposed about the deformable body portion and between the first and second components such that the two components do not come into direct contact when the head portion of the fastener is secured against a top surface of the first component.

13. The fastener as recited in claim 10, wherein the PCB is a flexible PCB electrically coupled to an antenna, the flexible PCB providing a grounding pathway between the antenna and the housing.

14. The fastener as recited in claim 13, wherein each of the plurality of protrusions have a tapered distal end.

15. The fastener as recited in claim 10, wherein the deformable body portion of the fastener has a variable cross-section configured to engage at least the threaded bore of the housing and a threaded bore of the flexible printed circuit board.

16. The fastener as recited in claim 15, wherein the housing is a conductive electronic device housing operative as a chassis ground for an antenna in electrical contact with the flexible PCB.

17. An electronic device, comprising:
a conductive housing having a threaded bore;
a fastener, comprising:
a deformable body portion having a first end configured to engage the threaded bore of the conductive housing; and
a printed circuit board secured to the threaded bore of the conductive housing by the fastener,
wherein when the first end of the deformable body portion is driven into the threaded bore, the first end deforms about a plurality of threads disposed within the threaded bore, thereby securing the first end of the deformable body portion within the threaded bore.

18. The electronic device as recited in claim 17, wherein the deformable body portion is constructed of a material that is substantially softer than the plurality of threads, thereby preventing damage to or deformation of the threaded bore when the fastener is inserted into or removed from the threaded bore.

19. The electronic device as recited in claim 18, wherein the deformable body portion of the fastener is made of a conductive polymer.

20. The electronic device as recited in claim 19, wherein the fastener electrically couples the printed circuit board to the conductive housing.
